(19) United States
(12) Patent Application Publication
(10) Pub. No.: US 2021/0207937 A1
(43) Pub. Date: Jul. 8, 2021

(54) GROOVE MEASUREMENT SYSTEM

(71) Applicant: Titus PVF Group Inc., Dallas, TX (US)

(72) Inventors: Jeremy David Cain, Dallas, TX (US); Garrett Daniel Holland, Dallas, TX (US); Paul Matthew Jaska, Dallas, TX (US); JohnRoss Johnson Pike, Dallas, TX (US); Dylan Andrew Ray, Dallas, TX (US); Tyler William Schardt, Dallas, TX (US)

(21) Appl. No.: 16/736,919

(22) Filed: Jan. 8, 2020

(51) Int. Cl. G01B 3/30

(52) U.S. Cl. CPC G01B 3/30

(57) ABSTRACT

Provided, in one aspect, is a groove measurement system. The groove measurement system, according to this aspect, includes a go measurement apparatus, the go measurement apparatus having first and second go gages protruding from one or more surfaces thereof, the first go gage having a go width (W_{G}) generally equal to a minimum desirable groove width (W_{MI}) of a desired groove, and the second go gage having a go depth (D_{G}) generally equal to the minimum desirable groove depth (D_{MI}). The groove measurement system, according to this aspect, additionally include a no-go measurement apparatus, the no-go measurement apparatus having first and second no-go gages protruding from one or more surfaces thereof, the first no-go gage having a no-go width (W_{NG}) greater than the maximum desirable groove width (W_{MA}), and the second no-go gage having a no-go depth (D_{NG}) generally equal to the maximum desirable groove depth (D_{MA}).

### TECHNICAL FIELD

This application is directed, in general, to measuring grooves in a pipe and, more specifically, to a groove measurement system and kit including the same.

### BACKGROUND

The use of grooved systems to connect and assemble piping is commonplace in a variety of applications crossing multiple industries, including oil-and-gas production, municipal water supply, building fire suppression systems, sanitation, storm drainage, as well as others applications. While the fittings may have grooved features easily cast or machined into the fitting body, the pipe must have a groove either cut through a metal-removal process (a form of machining) or rolled through a metal-forming process.

Often the construction of piping facilities requires that the pipe be cut to length on-site, for example to take into account construction tolerances and the difference between ideal and as-built designs. This precludes the ability to pre-cut and pre-groove pipe in a shop environment, where more precise processes and tools may be used to create grooves and ensure that the grooves meet industry specification to guarantee fit and function. Accordingly, the industry currently recommends the use of a pi-tape, which is a precision measuring instrument that allows direct diametric measurements by means of measuring the circumference of the groove, or an OD micrometer, which directly measures the OD of the groove.

A consequence of the relatively high cost and fragility of these precision instruments, coupled with the skill level required to use them effectively, limits their use in the field during construction of piping systems. The result is little or no measurement or the use of mating components and test-fitting as the measurement tool, neither of which ensures that grooves are machined correctly. This often results in form, fit, and function issues when pipe grooved in the field is used in the construction of piping systems, potentially including loss of pressure containment.

More archaic and less-accurate tools, such as a spring caliper and divider (which for example employs points to mechanically determine the diameter and then the distance between these points is measured on a ruler) may also be used. Unfortunately, the incremental resolution available in most rulers and machinist scales is larger than the tolerance range afforded by the industry code that defines the limits of these grooved profiles. This ultimately results in poor accuracy, which may also impact the form, fit, and function of grooved products integrated into piping systems.

### BRIEF DESCRIPTION

Reference is now made to the following descriptions taken in conjunction with the accompanying drawings, in which:

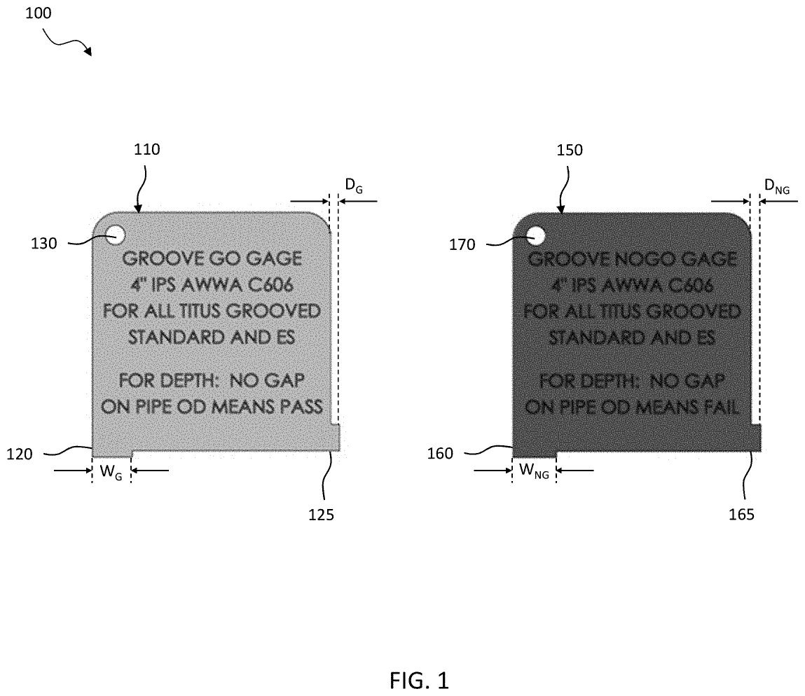

FIGS. 1-3 illustrate various different embodiments of a groove measurement system manufactured and designed according to the principles of the disclosure;

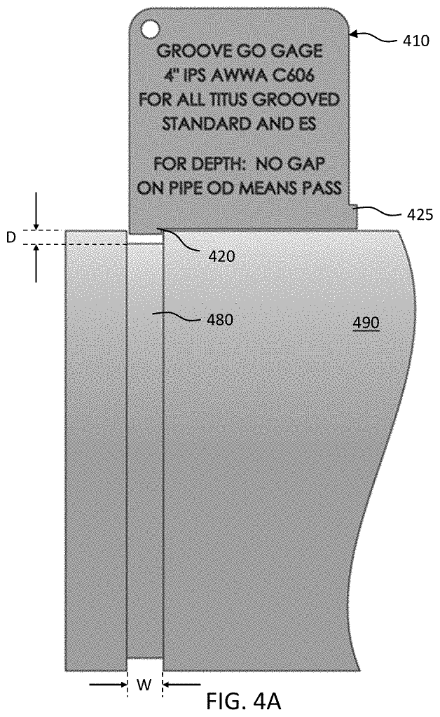

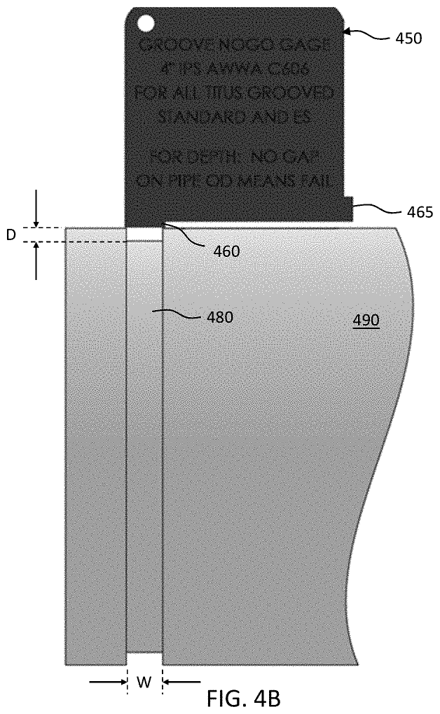

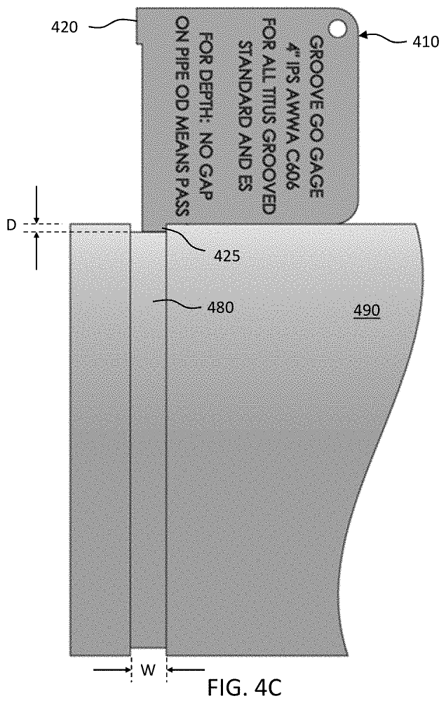

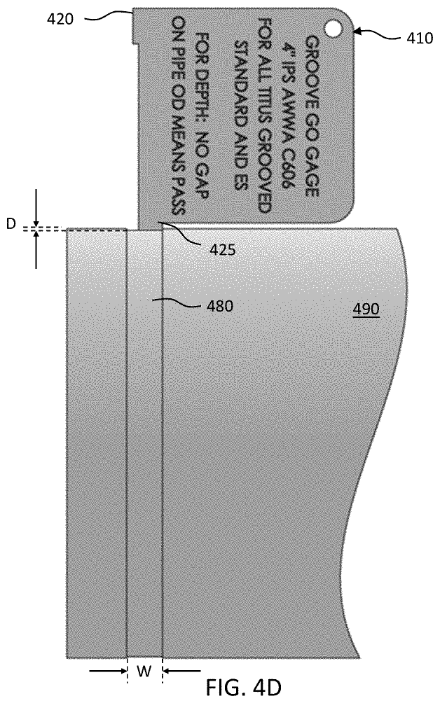

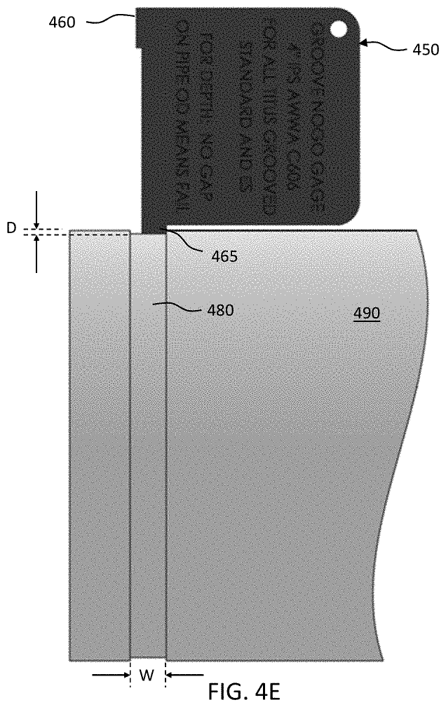

FIGS. 4A-4F illustrate examples how a go measurement apparatus and no-go measurement apparatus might be used to easily measure the acceptability of a groove located within a pipe;

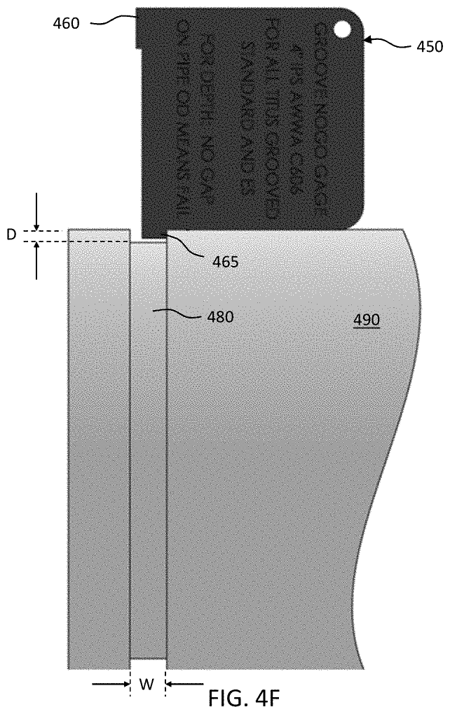

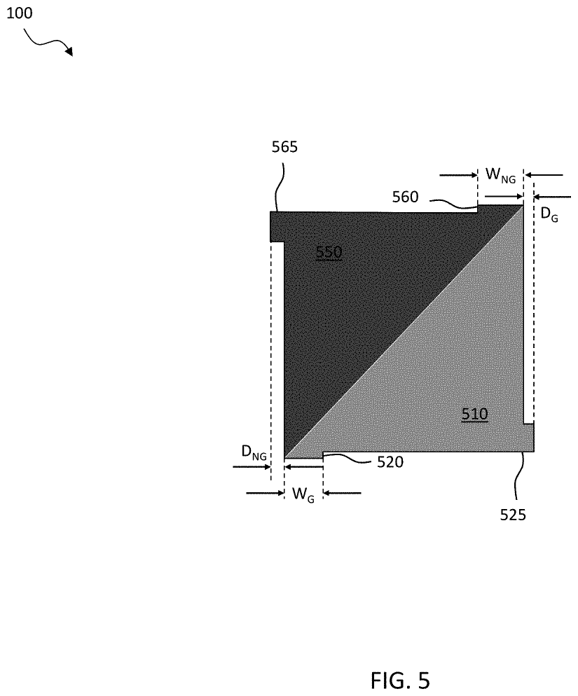

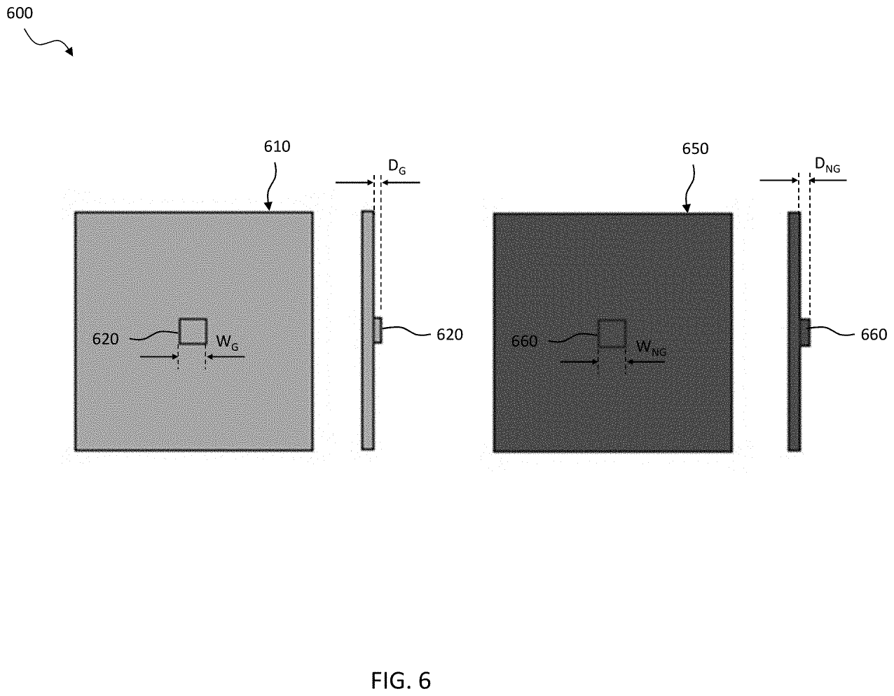

FIGS. 5-6 illustrate various different embodiments of a groove measurement system manufactured and designed according to the principles of the disclosure;

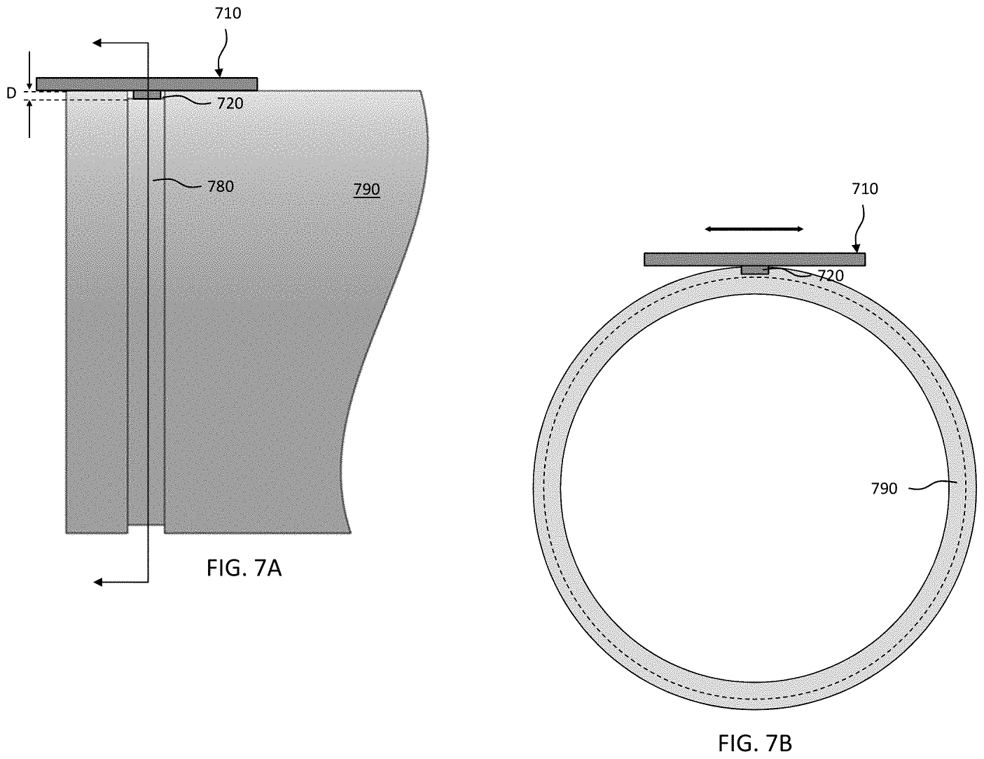

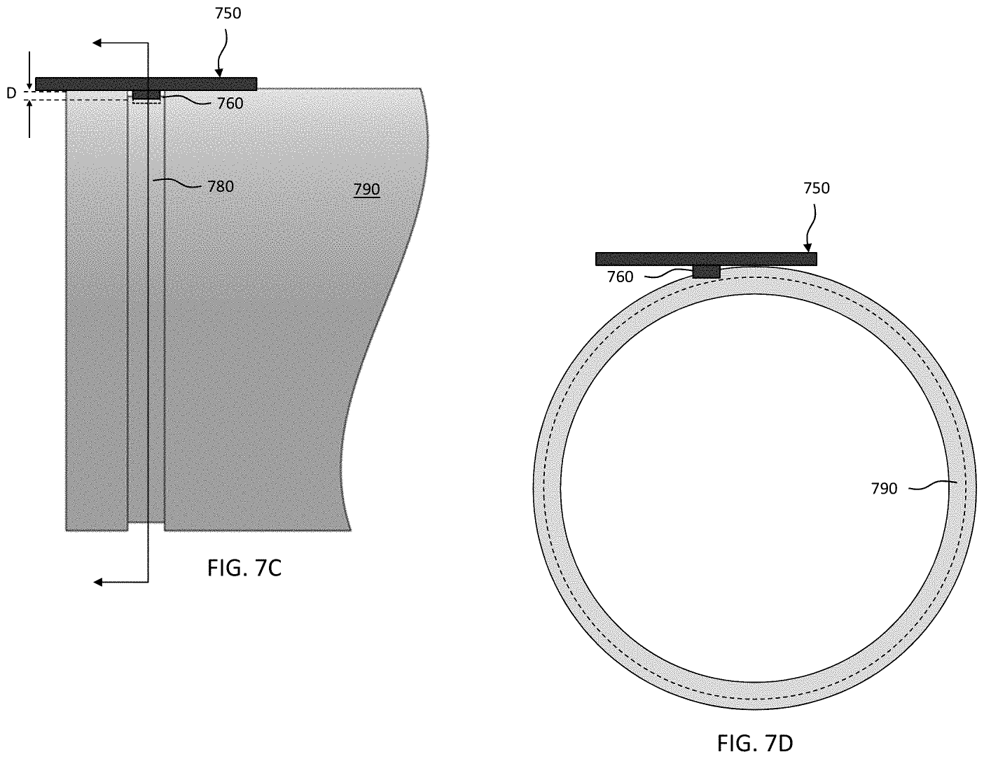

FIGS. 7A-7D illustrate examples how a go measurement apparatus and a no-go measurement apparatus, similar to that shown in FIG. 6, might be used to easily measure the acceptability of a groove located within a pipe; and

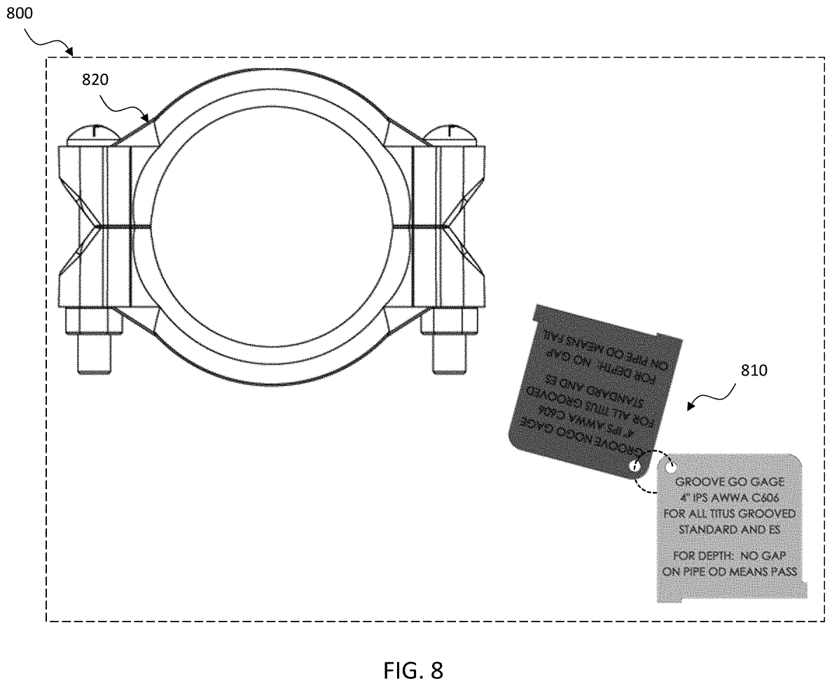

FIG. 8 illustrates a groove measurement kit designed, manufactured and sold according to the disclosure.

### DETAILED DESCRIPTION

In the drawings and descriptions that follow, like parts are typically marked throughout the specification and drawings with the same reference numerals, respectively. The drawn figures are not necessarily, but may be, to scale. Certain features of the disclosure may be shown exaggerated in scale or in somewhat schematic form and some details of certain elements may not be shown in the interest of clarity and conciseness. The present disclosure may be implemented in embodiments of different forms. Specific embodiments are described in detail and are shown in the drawings, with the understanding that the present disclosure is to be considered an exemplification of the principles of the disclosure, and is not intended to limit the disclosure to that illustrated and described herein. It is to be fully recognized that the different teachings of the embodiments discussed herein may be employed separately or in any suitable combination to produce desired results. Moreover, all statements herein reciting principles and aspects of the disclosure, as well as specific examples thereof, are intended to encompass equivalents thereof. Additionally, the term, “or,” as used herein, refers to a non-exclusive or, unless otherwise indicated.

Unless otherwise specified, use of the terms “connect,” “engage,” “couple,” “attach,” or any other like term describing an interaction between elements is not meant to limit the interaction to direct interaction between the elements and may also include indirect interaction between the elements described.

The present disclosure, in a broad sense, is directed to a groove measurement system (e.g., a set of fixed gages in one embodiment) that can be used (e.g., in the field) to evaluate whether a groove machined in pipe is within specification, utilizing for example tolerances from the ASME code for pipe and the AWWA code for grooves. A groove measurement system according to the present disclosure is based on the principle of “go and no-go”.

In accordance with one embodiment of the disclosure, for each size of grooved pipe, there are two measurement apparatuses, including a go measurement apparatus and a no-go measurement apparatus. In accordance with one embodiment, each measurement apparatus includes two gages. For example, in one embodiment, each of the measurement apparatuses includes two separate protrusions, one measuring width and the other measuring depth. In another embodiment, each measurement apparatus includes a single three-dimensional protrusion, each single three-dimensional protrusion measuring the depth.

Turning to FIG. 1, illustrated is a groove measurement system 100 manufactured and designed according to the principles of the disclosure. The groove measurement system 100, in the illustrated embodiment, includes a go measurement apparatus 110 and a no-go measurement apparatus 150. The go measurement apparatus 110, in the illustrated embodiment of FIG. 1, includes first and second go gages 120, 125 protruding from one or more surfaces thereof.

In accordance with one embodiment of the disclosure, the first go gage 120 has a go width (W_{G}) generally equal to a minimum desirable groove width (W_{MI}) of a desired groove. In accordance with another embodiment, the first go gage 120 has a go width (W_{G}) substantially equal to a minimum desirable groove width (W_{MI}) of a desired groove, and in yet another embodiment, the first go gage 120 has a go width (W_{G}) ideally equal to a minimum desirable groove width (W_{MI}) of a desired groove.

In accordance with one embodiment of the disclosure, the second go gage 125 has a go depth (D_{G}) generally equal to the minimum desirable groove depth (D_{MI}) of the desired groove. In accordance with another embodiment of the disclosure, the second go gage 125 has a go depth (D_{G}) substantially equal to the minimum desirable groove depth (D_{MI}) of the desired groove, and in yet another embodiment the second go gage 125 has a go depth (D_{G}) ideally equal to the minimum desirable groove depth (D_{MI}) of the desired groove.

The no-go measurement apparatus 150, in the illustrated embodiment of FIG. 1, includes first and second no-go gages 160, 165 protruding from one or more surfaces thereof. In one embodiment, the first no-go gage 160 has a no-go width (W_{NG}) greater than the maximum desirable groove width (W_{MA}) of the desired groove. Additionally, the second no-go gage 165 may have a no-go depth (D_{NG}) generally equal to the maximum desirable groove depth (D_{MA}) of the desired groove. In another embodiment, the second no-go gage 165 has a no-go depth (D_{NG}) substantially equal to the maximum desirable groove depth (D_{MA}) of the desired groove, and in yet another embodiment the second no-go gage 165 has a no-go depth (D_{NG}) ideally equal to the maximum desirable groove depth (D_{MA}) of the desired groove.

The phrase “desired groove,” as used herein, is referencing a preexisting pipe/groove combination, for example having tolerances from the ASME code for pipe and the AWWA code for grooves. Accordingly, in most instances, the minimum and maximum desirable groove widths and depths are set by ASME and AWWA, of which may be used to design and manufacture the groove measurement system 100 according to the disclosure. The minimum desirable groove width (W_{MI}) and the maximum desirable groove width (W_{MA}) may be used to calculate (e.g., by subtracting the maximum desirable groove width (W_{MA}) from the minimum desirable groove width (W_{MI})) a groove width tolerance for a desired groove. The minimum desirable groove depth (D_{MI}) and the maximum desirable groove depth (D_{MA}) may be used to calculate (e.g., by subtracting the maximum desirable groove depth (D_{MA}) from the minimum desirable groove depth (D_{MI})) a groove depth tolerance for a desired groove.

The phrase “generally equal to the minimum desirable groove width,” as used herein, means that the first go gage 120 has a go width (W_{G}) ranging from the minimum desirable groove width (W_{MI}) to 50% of the groove width tolerance greater than the minimum desirable groove width (W_{MI}). Thus, as an example, if the minimum desirable groove width (W_{MI}) were 20 mm and the maximum desirable groove width (W_{MA}) were 22 mm, and thus the groove width tolerance were 2 mm, a go width (W_{G}) that was “generally equal to the minimum desirable groove width” would range from 20 mm to 21 mm.

The phrase “substantially equal to the minimum desirable groove width,” as used herein, means that the first go gage 120 has a go width (W_{G}) ranging from the minimum desirable groove width (W_{MI}) to 15% of the groove width tolerance greater than the minimum desirable groove width (W_{MI}). Thus, as an example, if the minimum desirable groove width (W_{MI}) were 20 mm and the maximum desirable groove width (W_{MA}) were 22 mm, and thus the groove width tolerance were 2 mm, a go width (W_{G}) that was “substantially equal to the minimum desirable groove width” would range from 20 mm to 20.3 mm.

The phrase “ideally equal to the minimum desirable groove width,” as used herein, means that the first go gage 120 has a go width (W_{G}) ranging from the minimum desirable groove width (W_{MI}) to 5% of the groove width tolerance greater than the minimum desirable groove width (W_{MI}). Thus, as an example, if the minimum desirable groove width (W_{MI}) were 20 mm and the maximum desirable groove width (W_{MA}) were 22 mm, and thus the groove width tolerance were 2 mm, a go width (W_{G}) that was “ideally equal to the minimum desirable groove width” would range from 20 mm to 20.1 mm.

The phrase “generally equal to the minimum desirable groove depth,” as used herein, means that the second go gage 125 has a go depth (D_{G}) ranging from the minimum desirable groove depth (D_{MI} to 50% of the groove depth tolerance less than the minimum desirable groove depth (D_{MI}). Thus, as an example, if the minimum desirable groove depth (D_{MI}) were 10 mm and the maximum desirable groove depth (D_{MA}) were 11 mm, and thus the groove depth tolerance were 1 mm, a go depth (D_{G}) that was “generally equal to the minimum desirable groove depth” would range from 10 mm to 9.5 mm.

The phrase “substantially equal to the minimum desirable groove depth.” as used herein, means that the second go gage 125 has a go depth (D_{G}) ranging from the minimum desirable groove depth (D_{MI}) to 15% of the groove depth tolerance less than the minimum desirable groove depth (D_{MI}). Thus, as an example, if the minimum desirable groove depth (D_{MI}) were 10 mm and the maximum desirable groove depth (D_{MA}) were 11 mm, and thus the groove depth tolerance were 1 mm, a go depth (D_{G}) that was “substantially equal to the minimum desirable groove depth” would range from 10 mm to 9.85 mm.

The phrase “ideally equal to the minimum desirable groove depth,” as used herein, means that the second go gage 125 has a go depth (D_{G}) ranging from the minimum desirable groove depth (D_{MI}) to 5% of the groove depth tolerance less than the minimum desirable groove depth (D_{MI}). Thus, as an example, if the minimum desirable groove depth (D_{MI}) were 10 mm and the maximum desirable groove depth (D_{MA}) were 11 mm, and thus the groove depth tolerance were 1 mm, a go depth (D_{G}) that was “ideally equal to the minimum desirable groove depth” would range from 10 mm to 9.95 mm.

The phrase “generally equal to the maximum desirable groove depth,” as used herein, means that the second no-go gage 165 has a no-go depth (D_{NG}) ranging from the maximum desirable groove depth (D_{MA}) to 50% of the groove depth tolerance less than the maximum desirable groove depth (D_{MA}). Thus, as an example, if the minimum desirable groove depth (D_{MI}) were 10 mm and the maximum desirable groove depth (D_{MA}) were 11 mm, and thus the groove depth tolerance were 1 mm, a no-go depth (D_{NG}) that was “generally equal to the maximum desirable groove depth” would range from 11 mm to 10.5 mm.

The phrase “substantially equal to the maximum desirable groove depth,” as used herein, means that the second no-go gage 165 has a no-go depth (D_{NG}) ranging from the maximum desirable groove depth (D_{MA}) to 15% of the groove depth tolerance less than the maximum desirable groove depth (D_{MA}). Thus, as an example, if the minimum desirable groove depth (D_{MI}) were 10 mm and the maximum desirable groove depth (D_{MA}) were 11 mm, and thus the groove depth tolerance were 1 mm, a no-go depth (D_{NG}) that was “substantially equal to the maximum desirable groove depth” would range from 11 mm to 10.85 mm.

The phrase “ideally equal to the maximum desirable groove depth,” as used herein, means that the second no-go gage 165 has a no-go depth (D_{NG}) ranging from the maximum desirable groove depth (D_{MA}) to 5% of the groove depth tolerance less than the maximum desirable groove depth (D_{MA}). Thus, as an example, if the minimum desirable groove depth (D_{MI}) were 10 mm and the maximum desirable groove depth (D_{MA}) were 11 mm, and thus the groove depth tolerance were 1 mm, a no-go depth (D_{NG}) that was “ideally equal to the maximum desirable groove depth” would range from 11 mm to 10.95 mm.

In the illustrated embodiment of FIG. 1, the groove measurement system 100 is configured for use with a specific desired groove, which in this embodiment is a 4 inch IPS AWWA C606 grooved pipe. Nevertheless, a groove measurement system 100 can, and most likely will, be preconfigured for use with all other currently known or hereafter designed grooved pipe.

In the illustrated embodiment of FIG. 1, the go measurement apparatus 110 comprises a first shape (e.g., a thin cube, thin cuboid, or thin polygon) having first and second major go surfaces joined together by one or more go edges. As the go measurement apparatus 110 takes the shape of a rectangle, the go measurement apparatus 110 includes four different thin go edges. Similarly, the no-go measurement apparatus 150 comprises a second shape including first and second major no-go surfaces joined together by one or more no-go edges. The no-go measurement apparatus 150 is of similar shape to the go measurement apparatus 110 (e.g., at least in the embodiment of FIG. 1), and thus also includes four different thin no-go edges. Notwithstanding, had the go measurement apparatus 110 and go measurement apparatus 150 taken the shape of a circle or oval, they would each only include a single go edge and no-go edge, respectively. Similarly, had the go measurement apparatus 110 and go measurement apparatus 150 taken the shape of a hexagon, they would each include five go edges and no-go edges, respectively, etc.

According to the embodiment of FIG. 1, the first go gage 120 and the second go gage 125 extend outwardly from the one or more go edges. In fact, in the embodiment of FIG. 1, the first go gage 120 extends from one go edge and the second go gage 125 extends from a different go edge. Similarly, and in accordance with the embodiment of FIG. 1, the first no-go gage 160 and second no-go gage 165 extend outwardly from the one or more no-go edges. In fact, in the embodiment of FIG. 1, the first no-go gage 160 extends outwardly from one no-go edge and the second no-go gage 165 extends outwardly from a different no-go edge.

The go measurement apparatus 110 and the no-go measurement apparatus 150, in the illustrated embodiment, are separate fixtures, as opposed to being formed as a single fixture as in later embodiments. In accordance with this embodiment, the go measurement apparatus 110 additionally includes a first hole 130 extending from the first major go surface to the second major go surface. Similarly, the no-go measurement apparatus 150, in the illustrated embodiment, additionally includes a second hole 170 extending from the first major no-go surface to the second major no-go surface. The first hole 130 and second hole 170, in this embodiment, may be used to movably couple the go measurement apparatus 110 and no-go measurement apparatus 150 together. In accordance with one embodiment, the first hole 130 and second hole 170 are similarly located so as to overlap when the go measurement apparatus 110 and the no-go measurement apparatus 150 are placed on top of one another.

In another embodiment, not specifically shown, the go measurement apparatus 110 and no-go measurement apparatus 150 comprise a single fixture, as opposed to the two separate fixtures shown in FIG. 1. In this embodiment, the single fixture would include first and second major surfaces joined together by at least two go edges and two no-go edges. Further to this embodiment, the first go gage 120 and the second go gage 125 extend outwardly from respective ones of the go edges and the first no-go gage 160 and second no-go gage 165 extend outwardly from respective ones of the no-go edges. Thus, unless otherwise required, the aspects of the present disclosure should not be limited to a single fixture or multiple fixtures.

In accordance with one embodiment, the groove measurement system 100 includes easily identifiable markings to differentiate the go measurement apparatus 110 from the no-go measurement apparatus 150. Such markings are quite helpful in those situations wherein the shape and measurement tolerances between the go measurement apparatus 110 and the no-go measurement apparatus 150 are small. In one particular embodiment, the go measurement apparatus 110 has an easily identifiable go marking and the no-go measurement apparatus 150 has an easily identifiable no-go marking. In the illustrated embodiment, the go marking is a first color (e.g., green) and the no-go marking is a second color (e.g., red). In another embodiment, the go marking is a check mark and the no-go marking is an X, or another combination of numbers and/or letters. In yet another embodiment, the go marking is go marking text displayed on the go measurement apparatus and the no-go marking is no-go marking text displayed on the no-go measurement apparatus, such as also included within the embodiment of FIG. 1. Those skilled in the art, given the present disclosure, may readily envision other types of go markings and no-go markings that might be used.

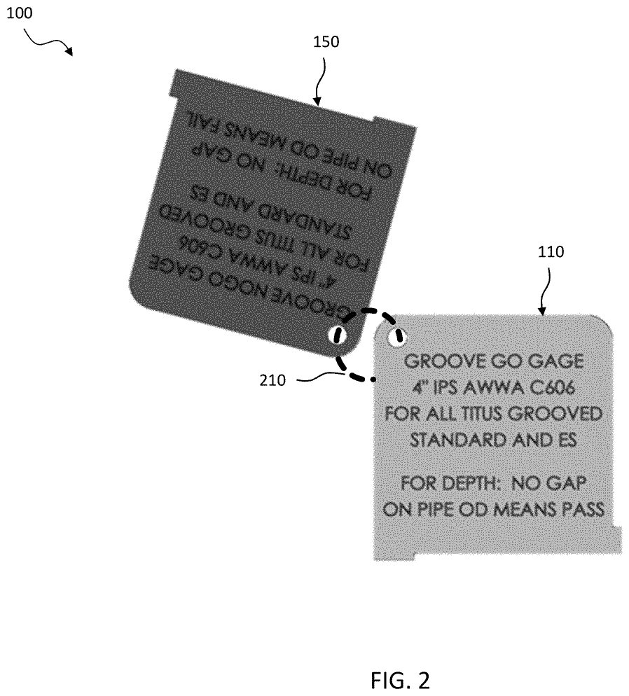

Turning briefly to FIG. 2, illustrated is the groove measurement system 100 of FIG. 1, wherein the go measurement apparatus 110 and the no-go measurement apparatus 150 are movably coupled to one another. In the illustrated embodiment of FIG. 2, a coupler 210 movably couples the go measurement apparatus 110 and the no-go measurement apparatus 150 together. The coupler 210, in the illustrated embodiment, functions much the same as a key ring would with a pair of keys, thereby allowing many degrees of coupled movement.

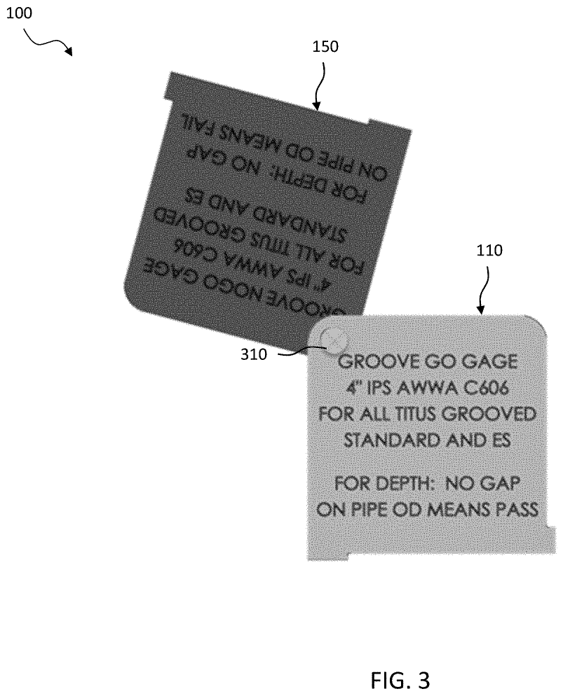

Turning briefly to FIG. 3, illustrated is the groove measurement system 100 of FIG. 1, wherein the go measurement apparatus 110 and the no-go measurement apparatus 150 are movably coupled to one another in an alternative manner. In the illustrated embodiment of FIG. 3, a coupler 310 movably couples the go measurement apparatus 110 and the no-go measurement apparatus 150 together. The coupler 310, in the illustrated embodiment, fixes the go measurement apparatus 110 and the no-go measurement apparatus 150 in substantial parallel relation to one another, but allows the go measurement apparatus 110 and the no-go measurement apparatus 150 to rotate and slide relative to one another. Accordingly, in one embodiment where the go measurement apparatus 110 and the no-go measurement apparatus 150 are similarly shaped, the go measurement apparatus 110 and the no-go measurement apparatus 150 may rotate and slide relative to one another such that their combined footprint is substantially similar to their individual footprints.

The coupler 310 may take on many different designs and remain within the purview of the disclosure. In one embodiment, the coupler 310 is a loosely fit rivet. In another embodiment, the coupler 310 is a threaded fastener that extends through the first and second holes 130, 150 and mates with a second corresponding fastener. While only a couple of designs have been described, illustrated and/or shown for the coupler 210, 310, those skilled in the art understand the myriad of different fasteners that might be used with a groove measurement system designed and manufactured according to the disclosure.

Turning now to FIGS. 4A-4F, illustrated are examples how a go measurement apparatus 410 and no-go measurement apparatus 450 might be used to easily measure the acceptability of a groove 480 located within a pipe 490. With initial reference to FIGS. 4A and 4B, the acceptability of the width (W) of the groove 480 is being tested. For instance, FIGS. 4A and 4B show the go measurement apparatus 410 and no-go measurement apparatus 450, respectively, being positioned proximate the groove 480 in the pipe 490.

FIG. 4A shows the first go gage 420 having a go width (W_{G}) generally equal to a minimum desirable groove width (W_{MI}) of a desired groove positioned proximate the groove 480. If the first go gage 420 fits within the groove 480, and thus there is no gap between a long edge of the go measurement apparatus 410 proximate the first go gage 420 and the outside diameter (“OD”) of the pipe 490, such as shown in FIG. 4A, then the width (W) of the groove 480 meets the minimum desirable groove width (W_{MI}). If the first go gage 420 does not fit within the groove 480, and thus a gap does exist between the long edge of the go measurement apparatus 410 proximate the first go gage 420 and the OD of the pipe 490 (e.g., a situation not shown), then the width (W) of the groove 480 does not meet the minimum desirable groove width (W_{MI}), and thus the width (W) of the groove 480 is unacceptable.

FIG. 4B shows the first no-go gage 460 having a no-go width (W_{NG}) greater than the maximum desirable groove width (W_{MA}) of the desired groove positioned proximate the groove 480. If the first no-go gage 460 does not fit within the groove 480, and thus there is a gap between a long edge of the no-go measurement apparatus 450 proximate the first no-go gage 460 and the outside diameter (“OD”) of the pipe 490, such as shown in FIG. 4B, then the width (W) of the groove 480 meets the maximum desirable groove width (W_{MA}). If the first no-go gage 460 fits within the groove 480, and thus a gap does not exist between the long edge of the no-go measurement apparatus 450 proximate the first no-go gage 460 and the OD of the pipe 490 (e.g., a situation not shown), then the width (W) of the groove 480 does not meet the maximum desirable groove width (W_{MA}), and thus the width (W) of the groove 480 is unacceptable.

In the illustrated embodiment of FIGS. 4A and 4B, the width (W) of the groove 480 meets both the minimum desirable groove width (W_{MI}) and maximum desirable groove width (W_{MA}), and thus the width (W) of the groove 480 is acceptable. Had the groove 480 not met either of the minimum desirable groove width (W_{MI}) or maximum desirable groove width (W_{MA}), the width (W) of the groove 480 would be unacceptable. Thus, using the go measurement apparatus 410 and no-go measurement apparatus 450, the acceptability of the width (W) of the groove 480 can be easily determined.

Turning to FIGS. 4C-4F, the acceptability of the depth (D) of the groove 480 is being tested. For instance, FIGS. 4C-4F show the go measurement apparatus 410 and no-go measurement apparatus 450, respectively, being positioned proximate the groove 480 in the pipe 490. FIG. 4C shows the second go gage 425 having a go depth (D_{G}) generally equal to the minimum desirable groove depth (D_{MI}) of the desired groove positioned proximate the groove 480. If when the second go gage 425 is placed within the groove 480 there is no gap between a long edge of the go measurement apparatus 410 proximate the second go gage 425 and the OD of the pipe 490, such as shown in FIG. 4C, the depth (D) of the groove 480 meets the minimum desirable groove depth (D_{MI}). In contrast, if when the second go gage 425 is positioned within the groove 480 a gap does exist between the long edge of the go measurement apparatus 410 proximate the second go gage 425 and the OD of the pipe 490, such as shown in FIG. 4D, the depth (D) of the groove 480 does not meet the minimum desirable groove depth (D_{MI}).

FIG. 4E shows the second no-go gage 465 having a no-go depth (D_{NG}) generally equal to the maximum desirable groove depth (D_{MA}) of the desired groove positioned proximate the groove 480. If when the second no-go gage 465 is placed within the groove 480 a gap does exist between a long edge of the go measurement apparatus 450 proximate the second no-go gage 465 and the OD of the pipe 490, such as shown in FIG. 4E, the depth (D) of the groove 480 meets the maximum desirable groove depth (D_{MA}). In contrast, if when the second no-go gage 465 is positioned within the groove 480 a gap does not exist between the long edge of the no-go measurement apparatus 450 proximate the second no-go gage 465 and the OD of the pipe 490, such as shown in FIG. 4F, the depth (D) of the groove 480 does not meet the maximum desirable groove depth (D_{MA}).

In the illustrated embodiment of FIGS. 4C and 4E, the depth (D) of the groove 480 meets both the minimum desirable groove depth (D_{MI}) and maximum desirable groove depth (D_{MA}), and thus the depth (D) of the groove 480 is acceptable. Had the groove 480 not met either of the minimum desirable groove depth (D_{MI}) or maximum desirable groove depth (D_{MA}), such as shown in either of the situations of FIGS. 4D and 4F, the depth (D) of the groove 480 would be unacceptable. Thus, using the go measurement apparatus 410 and no-go measurement apparatus 450, the acceptability of the depth (D) of the groove 480 can also be easily determined.

Turning now to FIG. 5, illustrated is an alternative embodiment of a groove measurement system 500 designed and manufactured according to the disclosure. The groove measurement system 500, in the illustrated embodiment, includes a go measurement apparatus 510 and a no-go measurement apparatus 550, which may be similar to the go measurement apparatus 110 and the no-go apparatus 150 illustrated in FIG. 1, with the exception that the go measurement apparatus 510 and a no-go measurement apparatus 550 are formed as a single fixture. In accordance with the embodiment of FIG. 5, the go measurement apparatus 510 and no-go measurement apparatus 550 comprise a single fixture including first and second major surfaces joined together by two go edges and two no-go edges. In the illustrated embodiment, a first go gage 520 and a second go gage 525 extend outwardly from respective ones of the go edges, and the first no-go gage 560 and second no-go gage 565 extend outwardly from respective ones of the no-go edges.

Turning now to FIG. 6, illustrated is an alternative embodiment of a groove measurement system 600 manufactured and designed according to the principles of the disclosure. The groove measurement system 600, in the illustrated embodiment, includes a go measurement apparatus 610 and a no-go measurement apparatus 650. The go measurement apparatus 610, in the illustrated embodiment of FIG. 6, includes a three-dimensional go gage 620 protruding from a surface (e.g., a major surface in the embodiment shown) thereof. In accordance with one embodiment, the three-dimensional go gage 620 has a go depth (D_{G}) generally equal to the minimum desirable groove depth (D_{MI}) of a desired groove. In accordance with another embodiment, the three-dimensional go gage 620 has a go width (W_{G}) generally equal to a minimum desirable groove width (W_{MI}) of the desired groove. In an alternative embodiment, the three-dimensional go gage 620 has a go width (W_{G}) substantially equal to a minimum desirable groove width (W_{MI}) of the desired groove, and in yet another embodiment the three-dimensional go gage 620 has a go width (W_{G}) ideally equal to a minimum desirable groove width (W_{MI}) of the desired groove.

Additionally, the no-go measurement apparatus 650, in the illustrated embodiment of FIG. 6, includes a second three-dimensional shape 660 protruding from one or more surfaces (e.g., a major surface in the embodiment shown) thereof. In accordance with one embodiment of the disclosure, the second three-dimensional shape 660 has a no-go depth (D_{NG}) generally equal to the maximum desirable groove depth (D_{MA}) of the desired groove. In another embodiment, the second three-dimensional shape 660 has a no-go width (W_{NG}) equal to or less than the maximum desirable groove width (W_{MA}) of the desired groove.

In the illustrated embodiment of FIG. 6, the go measurement apparatus 610 and the no-go measurement apparatus 650 comprise separate fixtures. For example, the go measurement apparatus 610 comprises a first shape (e.g., a thin cube, thin cuboid, or thin polygon) having first and second major go surfaces joined together by one or more go edges. Similarly, the no-go measurement apparatus 650 comprises a second shape including first and second major no-go surfaces joined together by one or more no-go edges. The no-go measurement apparatus 650 is of similar shape to the go measurement apparatus 610 (e.g., at least in the embodiment of FIG. 6), and thus also includes four different thin no-go edges.

According to the embodiment of FIG. 6, the three-dimensional go gage 620 extends outwardly from one of the first or second major go-surfaces, and the three-dimensional no-go gage 660 extends outwardly from one of the first or second major no-go surfaces. The three-dimensional go gage 620 and three-dimensional no-go gage 660 are illustrated in the embodiment of FIG. 6 as having a square footprint. Accordingly, when in use, the go measurement apparatus 610 and the no-go measurement apparatus 650 may be rotated at 0, 90, 180° and 270° (e.g., relatively) and still function for their intended purpose. Had the footprint of the three-dimensional go gage 620 and three-dimensional no-go gage 660 been a rectangle or another possible shape, such would not be the case and could conceivably be confusing to the user.

In an alternative embodiment (e.g., not shown), the three-dimensional go gage 620 and three-dimensional no-go gage 660 could have a circular footprint, and thus the go width (W_{G}) is a go diameter (D_{G}) of the circular footprint. Accordingly, when the circular embodiment is employed, the go measurement apparatus 610 and the no-go measurement apparatus 650 may be rotated at any position (e.g., 0° to 359° and still function as intended). Notwithstanding the foregoing, unless otherwise required, the footprint of the three-dimensional go gage 620 and three-dimensional no-go gage 660 should not be limited to a square, a circle, or any other specific shape.

The go measurement apparatus 610 and the no-go measurement apparatus 650, in the illustrated embodiment of FIG. 6, are separate fixtures. In another embodiment, not specifically shown, the go measurement apparatus 610 and no-go measurement apparatus 650 comprise a single fixture, as opposed to the two separate fixtures shown in FIG. 6. In this embodiment, the single fixture could include first and second major surfaces joined together by one or more edges. Further to this embodiment, the three-dimensional go gage 620 and three-dimensional no-go gage 660 would extend outwardly from the first and second major surfaces, respectively. Nevertheless, unless otherwise required, the aspects of the present disclosure should not be limited to a single fixture or multiple fixtures.

Turning now to FIGS. 7A-7D, illustrated are examples how a go measurement apparatus 710 and a no-go measurement apparatus 750 might be used to easily measure the acceptability of a groove 780 located within a pipe 790. FIGS. 7A and 7B shows the three-dimensional go gage 720 of the go measurement apparatus 710 positioned proximate the groove 780. The three-dimensional go gage 720, in the illustrated embodiment, has a go depth (D_{G}) generally equal to the minimum desirable groove depth (D_{MI}) of a desired groove. In certain other embodiments, the three-dimensional go gage 720 has a go width (W_{G}) generally equal to a minimum desirable groove width (W_{MI}) of the desired groove. If the three-dimensional go gage 720 fits within the groove 780 and there is no gap between the first major surface and the OD of the pipe 790, such as shown in FIGS. 7A and 7B, then the depth (D) of the groove 780 meets the minimum desirable groove depth (D_{MI}). Such can be easily tested by moving the go measurement apparatus across the OD of the pipe while the three-dimensional go gage 720 is within the groove 780, such as shown in FIG. 7B. If a gap exists between the first major surface and the OD of the pipe 790, or the go measurement apparatus cannot move across the OD of the pipe while the three-dimensional go gage 720 is within the groove 780, the groove 780 is unacceptable.

FIGS. 7C and 7D show the three-dimensional no-go gage 760 of the no-go measurement apparatus 750 positioned proximate the groove 780. The three-dimensional no-go gage 760, in the illustrated embodiment, has a no-go depth (D_{NG}) generally equal to the maximum desirable groove depth (D_{MA}) of the desired groove. If the three-dimensional no-go gage 760 does not fit within the groove 780 and there is a gap between the first major surface and the OD of the pipe 790, or the no-go measurement apparatus 750 cannot be moved across the OD of the pipe 790 while the three-dimensional no-go gage 760 is within the groove 780 without getting caught up, such as shown in FIG. 7D, then the depth (D) of the groove 780 meet the minimum desirable groove depth (D_{MI}). If, however, a gap does not exist between the first major surface and the OD of the pipe 790, or the no-go measurement apparatus 750 can be moved across the OD of the pipe 790 while the three-dimensional no-go gage 760 is within the groove 780 without getting caught up, the groove 780 is unacceptable.

Turning now to FIG. 8, illustrated is a groove measurement kit 800 designed, manufactured and sold according to the disclosure. The groove measurement kit 800 includes one or more groove measurement systems 810 designed and manufactured according to the disclosure. The groove measurement system 810 may be similar to any groove measurement system according to the disclosure, including the groove measurement systems 100, 500, 600 illustrated and described above with respect to FIGS. 1, 5 and 6, without limitation. The groove measurement kit 800 additionally includes a coupling 820, which in one embodiment has one or more lips configured to engage with one or more desired grooves in a pipe. Any coupling 820 currently known or hereafter discovered may be used and remain within the scope of the disclosure. Nevertheless, in one embodiment, the coupling 820 would be configured for a specific desired groove, while the groove measurement system 810 would be configured to measure such desired groove when in the field.

Those skilled in the art to which this application relates will appreciate that other and further additions, deletions, substitutions and modifications may be made to the described embodiments.

What is claimed is:

1. A groove measurement system, comprising:
a go measurement apparatus, the go measurement apparatus having first and second go gages protruding from one or more surfaces thereof, the first go gage having a go width (W_{G}) generally equal to a minimum desirable groove width (W_{MI}) of a desired groove, and the second go gage having a go depth (D_{G}) generally equal to the minimum desirable groove depth (D_{MI}) of the desired groove; and
a no-go measurement apparatus, the no-go measurement apparatus having first and second no-go gages protruding from one or more surfaces thereof, the first no-go gage having a no-go width (W_{NG}) greater than the maximum desirable groove width (W_{MA}) of the desired groove, and the second no-go gage having a no-go depth (D_{NG}) generally equal to the maximum desirable groove depth (D_{MA}) of the desired groove.

2. The groove measurement system as recited in claim 1, wherein the go measurement apparatus comprises a first shape including first and second major go surfaces joined together by one or more go edges, and further wherein the no-go measurement apparatus comprises a second shape including first and second major no-go surfaces joined together by one or more no-go edges.

3. The groove measurement system as recited in claim 2, wherein the first go gage and the second go gage extend outwardly from the one or more go edges, and the first no-go gage and second no-go gage extend outwardly from the one or more no-go edges.

4. The groove measurement system as recited in claim 3, wherein the first and second major go surfaces are joined together by two or more go edges and the first go gage and the second go gage extend outwardly from different edges of the two or more go edges, and further wherein the first and second major no-go surfaces are joined together by two or more no-go edges and the first no-go gage and the second no-go gage extend outwardly from different edges of the two or more no-go edges.

5. The groove measurement system as recited in claim 2, wherein the go measurement apparatus and the no-go measurement apparatus are separate fixtures movably coupled together.

6. The groove measurement system as recited in claim 5, wherein the go measurement apparatus includes a first hole extending between the first and second major go surfaces, and the no-go measurement apparatus includes a second hole extending between the first and second no-go surfaces, and further wherein a coupler extends through each of the first hole and second hole to movably couple the go measurement apparatus and the no-go measurement apparatus together.

7. The groove measurement system as recited in claim 6, wherein the coupler fixes the go measurement apparatus and the no-go measurement apparatus in substantial parallel relation to one another but allows the go measurement apparatus and the no-go measurement apparatus to rotate and slide relative to one another.

8. The groove measurement system as recited in claim 1, wherein the go measurement apparatus and no-go measurement apparatus comprise a single fixture including first and second major surfaces joined together by two go edges and two no-go edges, and further wherein the first go gage and the second go gage extend outwardly from respective ones of the go edges and the first no-go gage and second no-go gage extend outwardly from respective ones of the no-go edges.

9. The groove measurement system as recited in claim 1, wherein the go measurement apparatus has an easily identifiable go marking and the no-go measurement apparatus has an easily identifiable no-go marking.

10. The groove measurement system as recited in claim 9, wherein the go marking is a first color and the no-go marking is a second different color.

11. The groove measurement system as recited in claim 10, wherein the first color is green and the second color is red.

12. The groove measurement system as recited in claim 9, wherein the go marking is a check mark and the no-go marking is an X.

13. The groove measurement system as recited in claim 9, wherein the go marking is go marking text displayed on the go measurement apparatus and the no-go marking is no-go marking text displayed on the no-go measurement apparatus.

14. The groove measurement system as recited in claim 1, wherein the first go gage has a go width (W_{G}) substantially equal to a minimum desirable groove width (W_{MI}) of the desired groove.

15. The groove measurement system as recited in claim 1, wherein the first go gage has a go width (W_{G}) ideally equal to a minimum desirable groove width (W_{MI}) of the desired groove.

16. The groove measurement system as recited in claim 1, wherein the second go gage has a go depth (D_{G}) substantially equal to the minimum desirable groove depth (D_{MI}) of the desired groove.

17. The groove measurement system as recited in claim 1, wherein the second go gage has a go depth (D_{G}) ideally equal to the minimum desirable groove depth (D_{MI}) of the desired groove.

18. The groove measurement system as recited in claim 1, wherein the second no-go gage having a no-go depth (D_{NG}) substantially equal to the maximum desirable groove depth (D_{MA}) of the desired groove.

19. The groove measurement system as recited in claim 1, wherein the second no-go gage having a no-go depth (D_{NG}) ideally equal to the maximum desirable groove depth (D_{MA}) of the desired groove.

20. A groove measurement system, comprising:
a go measurement apparatus, the go measurement apparatus having a three-dimensional go gage protruding from a surface thereof, the three-dimensional go gage having a go depth (D_{G}) generally equal to the minimum desirable groove depth (D_{MI}) of a desired groove; and
a no-go measurement apparatus, the no-go measurement apparatus having a three-dimensional no-go gage protruding from a surface thereof, the three-dimensional no-go gage having a no-go depth (D_{NG}) generally equal to the maximum desirable groove depth (D_{MA}) of the desired groove.

21. The groove measurement system as recited in claim 20, wherein the three-dimensional go gage has a go width (W_{G}) generally equal to a minimum desirable groove width (W_{MI}) of the desired groove, and the three-dimensional no-go gage has a no-go width (W_{NG}) equal to or less than the maximum desirable groove width (W_{MA}) of the desired groove.

22. The groove measurement system as recited in claim 21, wherein the three-dimensional go gage has a square footprint.

23. The groove measurement system as recited in claim 21, wherein the three-dimensional go gage has a circular footprint, and the go width (W_{G}) is a go diameter (D_{G}) of the circular footprint.

24. The groove measurement system as recited in claim 20, wherein the three-dimensional go gage has a go width (W_{G}) substantially equal to a minimum desirable groove width (W_{MI}) of the desired groove, and the three-dimensional no-go gage has a no-go width (WNG) equal to or less than the maximum desirable groove width (W_{MA}) of the desired groove.

25. The groove measurement system as recited in claim 20, wherein the three-dimensional go gage has a go width (W_{G}) ideally equal to a minimum desirable groove width (W_{MI}) of the desired groove, and the three-dimensional no-go gage has a no-go width (W_{NG}) equal to or less than the maximum desirable groove width (W_{MA}) of the desired groove.

26. The groove measurement system as recited in claim 20, wherein the go measurement apparatus and no-go measurement apparatus comprise a single fixture including first and second major surfaces joined together by one or more edges, and further wherein the three-dimensional go gage extends from the first major surface, and the three-dimensional no-go gage extends from the second major surface.

27. A groove measurement kit, comprising:
a coupling having one or more lips configured to engage with one or more desired grooves in a pipe; and
a groove measurement system, the groove measurement system including:
a go measurement apparatus, the go measurement apparatus having first and second go gages protruding from one or more surfaces thereof, the first go gage having a go width (W_{G}) generally equal to a minimum desirable groove width (W_{MI}) of the desired groove, and the second go gage having a go depth (D_{G}) generally equal to the minimum desirable groove depth (D_{MI}) of the desired groove; and
a no-go measurement apparatus, the no-go measurement apparatus having first and second no-go gages protruding from one or more surfaces thereof, the first no-go gage having a no-go width (W_{NG}) greater than the maximum desirable groove width (W_{MA}) of the desired groove, and the second no-go gage having a no-go depth (D_{NG}) generally equal to the maximum desirable groove depth (D_{MA}) of the desired groove.

28. The groove measurement kit as recited in claim 27, wherein the go measurement apparatus comprises a first shape including first and second major go surfaces joined together by one or more go edges, and further wherein the no-go measurement apparatus comprises a second shape including first and second major no-go surfaces joined together by one or more no-go edges.

29. The groove measurement kit as recited in claim 28, wherein the first go gage and the second go gage extend outwardly from the one or more go edges, and the first no-go gage and second no-go gage extend outwardly from the one or more no-go edges.

30. The groove measurement kit as recited in claim 29, wherein the first and second major go surfaces are joined together by two or more go edges and the first go gage and the second go gage extend outwardly from different edges of the two or more go edges, and further wherein the first and second major no-go surfaces are joined together by two or more no-go edges and the first no-go gage and the second no-go gage extend outwardly from different edges of the two or more no-go edges.

31. The groove measurement kit as recited in claim 28, wherein the go measurement apparatus and the no-go measurement apparatus are separate fixtures movably coupled together.

32. The groove measurement kit as recited in claim 31, wherein the go measurement apparatus includes a first hole extending between the first and second major go surfaces, and the no-go measurement apparatus includes a second hole extending between the first and second no-go surfaces, and further wherein a coupler extends through each of the first hole and second hole to movably couple the go measurement apparatus and the no-go measurement apparatus together.

33. The groove measurement kit as recited in claim 32, wherein the coupler fixes the go measurement apparatus and the no-go measurement apparatus in substantial parallel relation to one another but allows the go measurement apparatus and the no-go measurement apparatus to rotate and slide relative to one another.
